(19) United States
(12) Patent Application Publication
(10) Pub. No.: US 2015/0050833 A1
(43) Pub. Date: Feb. 19, 2015

(54) CABLE UNIT FOR VEHICLE

(71) Applicants: Toyota Jidosha Kabushiki Kaisha, Toyota-shi (JP); Sumitomo Wiring Systems, Ltd., Yokkaichi (JP)

(72) Inventors: Tatsuhiko Mizutani, Toyota-shi (JP); Haruki Kusamaki, Toyota-shi (JP); Takuya Tate, Yokkaichi (JP); Hiroyuki Matsuoka, Yokkaichi (JP); Hirotaka Baba, Yokkaichi (JP); Tetsuya Iida, Yokkaichi (JP); Junpei Nakamoto, Yokkaichi (JP)

(21) Appl. No.: 14/458,574

(22) Filed: Aug. 13, 2014

(30) Foreign Application Priority Data
Aug. 19, 2013 (JP) 2013-169618

(51) Int. Cl. B60L 1/00

(52) U.S. Cl. CPC B60L 1/00
USPC 439/527

(57) ABSTRACT

A cable unit includes a first connector, a second connector, and a cable. The first connector is connected with a terminal block of a transaxle case. The second connector is connected with a terminal block of a power control unit case. The cable connects the first connector with the second connector. The cable is routed into a curved shape to be curved three-dimensionally. And the cable is deformed when the transaxle case and the power control unit case move relative to each other as a vehicle is driven.

### INCORPORATION BY REFERENCE

The disclosure of Japanese Patent Application No. 2013-169618 filed on Aug. 19, 2013 including the specification, drawings and abstract is incorporated herein by reference in its entirety.

### BACKGROUND OF THE INVENTION

1. Field of the Invention

The invention relates to a cable unit connected between electric equipment installed in a vehicle.

2. Description of Related Art

In a vehicle such as a hybrid vehicle and an electric vehicle using a rotating electric machine as a driving source, a direct current power source such as a battery and an inverter that converts direct current power into alternating current power.

The rotating electric machine and the inverter are electrically connected with each other by a cable unit. Specifically, as shown in FIG. 6, a cable unit 104 is connected with a terminal block 112 of a transaxle case 100 (herein below, referred to as a T/A case) that houses rotating electric machines MG1, MG2, and a terminal block 114 of a power control unit case 102 (herein below, referred to as a PCU case) that houses an inverter INV. The cable unit 104 includes a T/A side connector 106 connected with the terminal block 112 of the T/A case 100, a PCU side connector 108 connected with the terminal block 114 of the PCU case 102, and a cable 110 that connects both of the connectors with each other.

The T/A case 100 and the PCU case 102 could move relative to each other due to vibration and so on of a vehicle. For example, in a case where the PCU case 102 is supported by the T/A case 100 through elastic members 111 such as rubber bushes, both of the T/A case 100 and the PCU case 102 move relative to each other in accordance with vibration of the vehicle. In order for the cable 110 to follow the relative movement, the cable 110 is sometimes routed (arranged) with slight play instead of connecting both of the terminal blocks 112, 114 with each other in the shortest distance by using the cable 110. For example, in FIG. 6, the cable 110 is arranged in an L shape, in other words, extended in a vertical direction and a horizontal direction. In Japanese Patent Application Publication No. 2012-48823 (JP 2012-48823 A), an absorbing part that absorbs displacement is provided in a wire harness. In Japanese Patent Application Publication No. 2011-62053 (JP 2011-62053 A), a clamp is provided in order to create a space between a plurality of cables.

### SUMMARY OF THE INVENTION

Depending on how a cable is routed, there is a possibility that the cable is damaged when the T/A case and the PCU case move relative to each other. In order to supply large current to a rotating electric machine, the cable has a plurality of bundled electric wire strands and thus has a large diameter. Therefore, the cable is difficult to be bent with respect to a load applied in an axis direction of the cable. In such a case, for example, a case where the PCU case and the T/A case move relative to each other in the vertical direction is assumed. As shown in FIG. 7, a load is applied to a vertical part 110A of the cable 110 in the axis direction of the cable, and the vertical part 110A is hardly deformed. On the other hand, a horizontal part 110B of the cable 110 receives the load and is deformed. This means that a deformed part concentrates on one part. At this time, a deformation amount of the horizontal part 110B is larger compared to a case where the deformed part is dispersed in the entire cable 110. As a result, damage such as disconnection could be caused because, for example, an end part 110C of the horizontal part 110B is bent excessively. Therefore, the object of the invention is to provide a cable unit that is able to restrain damage of a cable more than before.

An aspect of a cable unit for a vehicle according to the invention includes the following structure. The cable unit comprises a first connector and a second connector and a cable. The first connector is connected with a terminal block of a transaxle case that houses a rotating electric machine. The second connector is connected with a terminal block of a power control unit case that houses an inverter. The cable that connects the first connector with the second connector. The cable is routed into a curved shape to be curved three-dimensionally. And the cable is deformed when the transaxle case and the power control unit case move relative to each other as the vehicle is driven.

According to the invention, it is possible to restrain damage of a cable more than before.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view showing an example of a cable unit according to an embodiment;

FIG. 2 is a schematic view explaining deformation of a cable;

FIG. 3 is a view showing an example of a part of the cable unit according to the embodiment;

FIG. 4 is a view showing another example of the cable unit according to the embodiment

FIG. 5 is a view showing another example of the cable unit according to the embodiment;

FIG. 6 is a view showing an example of a cable unit according to the related art; and

FIG. 7 is a schematic view explaining damage of a cable.

### DETAILED DESCRIPTION OF EMBODIMENTS

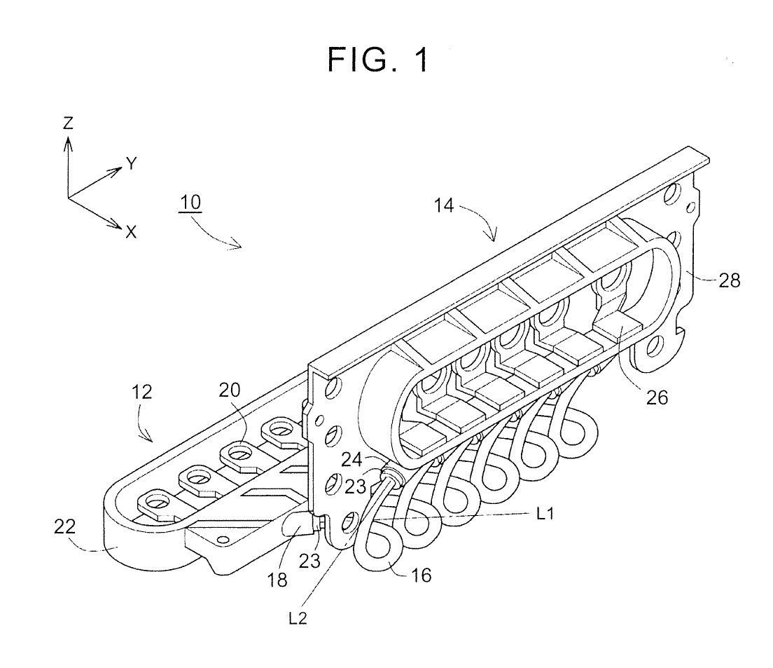

FIG. 1 shows an example of a cable unit 10 according to an embodiment. The cable unit 10 electrically connects an inverter and a rotating electric machine. To be specific, the cable unit 10 is connected with a terminal block of a transaxle case (herein after, referred to as a T/A case) that houses the rotating electric machine, and a terminal block of a power control unit case (herein after, referred to as a PCU case) that houses the inverter.

When the cable unit 10 is connected with the terminal blocks of the T/A case and the PCU case, the cable unit 10 is positioned so that a part of the cable unit 10 is hidden behind the T/A case and the PCU case. FIG. 1 to FIG. 5 show an example where the cable unit 10 is connected to the terminal blocks of the T/A case and the PCU case. However, in order to clearly show a whole image of the cable unit 10, illustration of the T/A case, the PCU case, and the terminals blocks of the T/A case and the PCU case is omitted.

As shown in FIG. 1, the cable unit 10 includes a T/A side connector 12, a PCU side connector 14, and cables 16. Considering that a magnetic field is generated when large current flows in the cable unit 10, the entire cable unit 10 may be covered with a shield made of a metallic material.

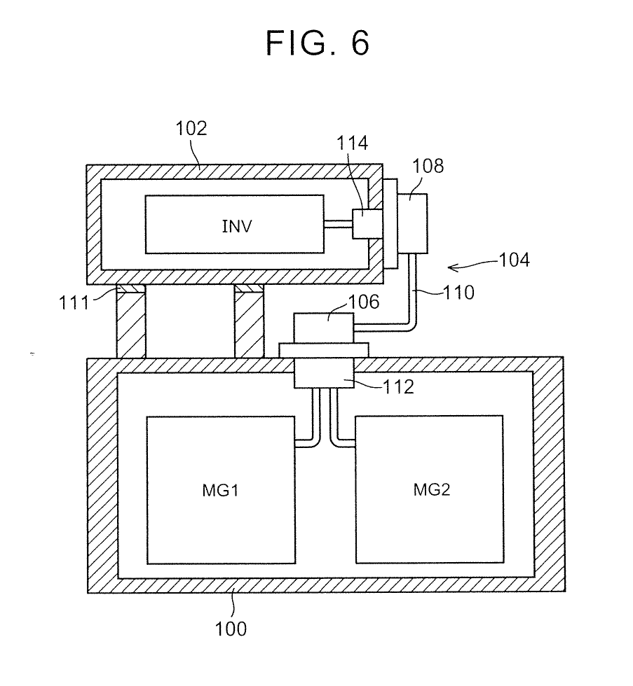

The T/A side connector 12 is connected with the terminal block of the T/A case. For example, as shown in FIG. 6, the terminal block of the T/A case is provided in a ceiling surface of the T/A case, and the T/A side connector is mounted on the ceiling surface. The T/A side connector 12 includes sockets 18, crimp terminals 20, and a cover 22.

The socket 18 is a female electronic component into which a plug 23 of the cable 16 is inserted. The plurality of sockets 18 are provided so as to be the same number as the crimp terminals 20. As described later, the socket 18 is formed so that an insertion direction axis L1 of the socket 18 is positioned to be skew to an insertion direction axis L2 of the socket 24 of the PCU side connector 14 when the cable unit 10 is connected with the T/A case and the PCU case.

The crimp terminal 20 is connected with a terminal of the terminal block, and is structured of for example, a round terminal. The plurality of crimp terminals 20 are provided corresponding to the number of the terminals of the terminal block. The cover 22 is a fixing member that fixes the T/A side connector 12 to the terminal block of the T/A case, and includes fixing means such as a threaded hole.

The PCU side connector 14 is connected with the terminal block of the PCU case. For example, as shown in FIG. 6, the terminal block is provided on a side surface of the PCU case, and the PCU side connector is mounted on a side surface of the terminal block. Since the T/A side connector 12 is mounted on the ceiling surface of the PCU case, the PCU side connector 14 is positioned to be generally a right angle to the T/A side connector 12. Similarly to the T/A side connector 12, the PCU side connector 14 includes sockets 24, crimp terminals 26, and a cover 28. The plurality of sockets 24 are provided to be the same number as the crimp terminals 26. The cover 28 is a fixing member that fixes the PCU side connector 14 to the terminal block of the PCU case, and includes a fixing means such as a threaded hole.

The cable 16 electrically connects the T/A side connector 12 with the PCU side connector 14. The plurality of cables 16 are provided to be the same number as the number of the crimp terminals 20 of the T/A side connector 12. In order to obtain a high output of the rotating electric machine, large current flows through the cable 16. Therefore, the cable 16 is formed of a plurality of electric wire strands that are bundled, and thus has a large diameter. As a result, the cable 16 has rigidity against a load applied in an axis direction of the able. In other words, the cable 16 is difficult to be bent with respect to a load applied in the axis direction. Further, the cable 16 has elasticity with respect to stress in directions other than the axis direction, and has such rigidity that allows stress applied on one end side to reach the other end so that the entire cable 16 is bent.

The cable 16 is routed in a curved shape that is curved three-dimensionally. In other words, the cable 16 is routed into a curved shape both in a view from the ceiling surface of the T/A case (an XY plane) and a view from a side surface of the PCU case (an XZ plane), which is orthogonal to the ceiling surface of the T/A case. In other words, the cable 16 is routed in a curved fashion so as to be displaced gradually from a direction parallel to the ceiling surface of the T/A case to a direction parallel to the side surface of the PCU case. In further other words, the cable 16 is routed to give a curved redundant part to an L-shaped straight line path that extends in a horizontal direction (an X axis direction) and a vertical direction (Z axis direction) from the T/A side connector 12 and is connected to the PCU side connector 14. The curved shape herein means non-linear shape, in short, curvature 1/r≢0 (curvature radius r≢∞).

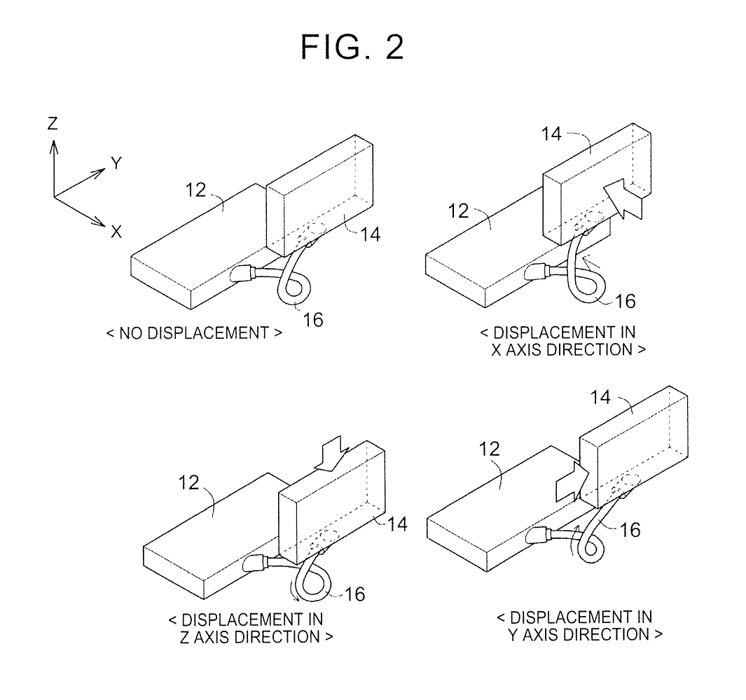

By curving the cable 16 three-dimensionally, the cable 16 is deformable by a load in any direction. FIG. 2 shows a schematic view of deformed states of the cable 16 when the T/A case and the PCU case move relative to each other. When the T/A case and the PCU case move relative to each other along the X axis direction (a short direction of the T/A side connector), the cable 16 is deformed into an elliptical spiral shape having a long axis in the X axis direction as shown in an upper right of the drawing. When the relative movement happens along the Y axis direction (a longitudinal direction of the T/A side connector), the cable 16 is deformed so that the spiral ring is shrunken as shown on the lower right of the drawing. When the relative movement happens in the Z axis direction (the vertical direction, a short direction of the PCU), the cable 16 is deformed so that the spiral ring expands as shown on the lower left of the drawing.

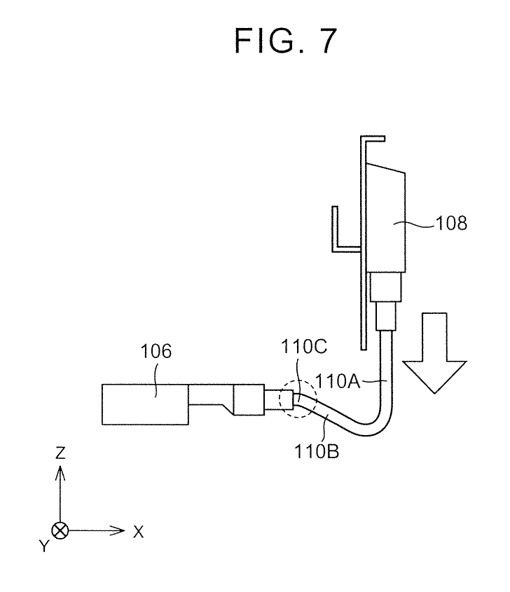

The cable 16 may be routed so as to curve over the entire length of the cable 16. The cable 16 may also include a straight part only to an extent with a negligible level of uneven deformation (for example, 10% of the entire length). As in the related art shown in FIG. 7, in a case where the cable 16 is routed so that the cable 16 is almost entirely made of a straight part, the straight part is not bent when a load in an axis direction parallel to the straight part is applied, and a deformation part concentrates on the remaining part. On the contrary, by arranging the cable 16 into a curved shape over the entire length of the cable 16, a part extending in parallel to a load reaction, or a straight part, is eliminated or becomes short enough to be negligible. Therefore, it is possible to deform the cable 16 over the entire length of the cable 16. As a result, compared to the case where only a part of the cable 16 is deformed, a deformation amount is dispersed when a load is applied on the cable 16 when, for example, the T/A case and the PCU case move to each other due to vibration and so on when a vehicle is driven. Hence, it is possible to avoid disconnection, breakage, and so on of the cable 16 caused by excessive deformation.

Referring back to FIG. 1, each of the sockets 18, 24 may be formed so that the insertion direction axis L1 of the socket 18 of the T/A side connector 12 and the insertion direction axis L2 of the socket 24 of the PCU side connector 14 are in a skew position with respect to each other, in other words, the insertion direction axes L1 and L2 are positioned not to be lined up on the same plane and to be non-parallel to each other in order to route the cable 16 into a three-dimensional curved shape.

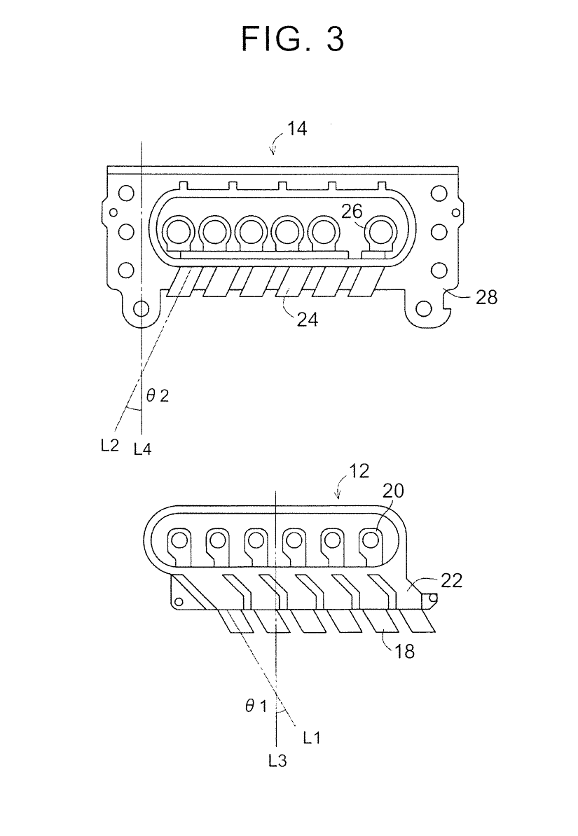

For example, as shown in FIG. 3, the insertion direction axis L1 of the socket 18 is inclined to the axis L3 of the short direction of the T/A side connector 12 (X axis). Similarly, the insertion direction axis L2 of the socket 24 is inclined to an axis L4 of the short direction of the PCU side connector 14 (Z axis). It is preferred that an angle θ1 of the insertion direction axis L1 to the axis L3 of the short direction, and an angle θ2 of the insertion direction axis L2 to the axis L4 of the short direction are different from each other. By doing so, the cable 16 is routed so that the cable 16 is extracted in directions inclined to the path according to the related art. The path according to the related art is the path in which the cable is routed into an L shape from the T/A side connector 12 to the PCU side connector 14. As a result, when the cable 16 is inserted into each of the sockets 18, 24, the cable 16 is routed in a spiral shape about the Z axis, and is curved three-dimensionally. The insertion direction axis coincides with an axis of the cable when inserted into each of the sockets 18, 24.

The sockets of either one of the T/A side connector 12 and the PCU side connector 14 may be inclined to the axis of the short direction of the corresponding connector, and the sockets of the other may be parallel to the axis of the short direction of the corresponding connector. This way, since the insertion direction axes L1 and L2 are also positioned to be skew to each other, it is possible to route the cable 16 into a spiral shape.

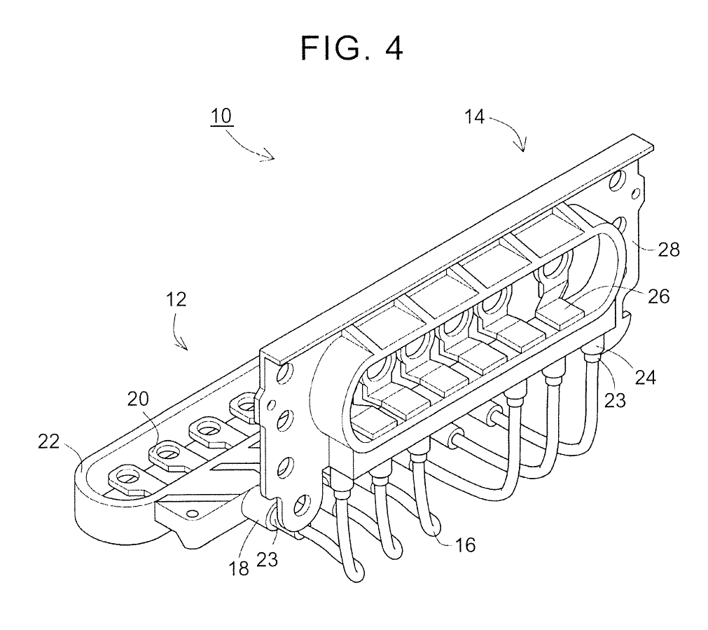

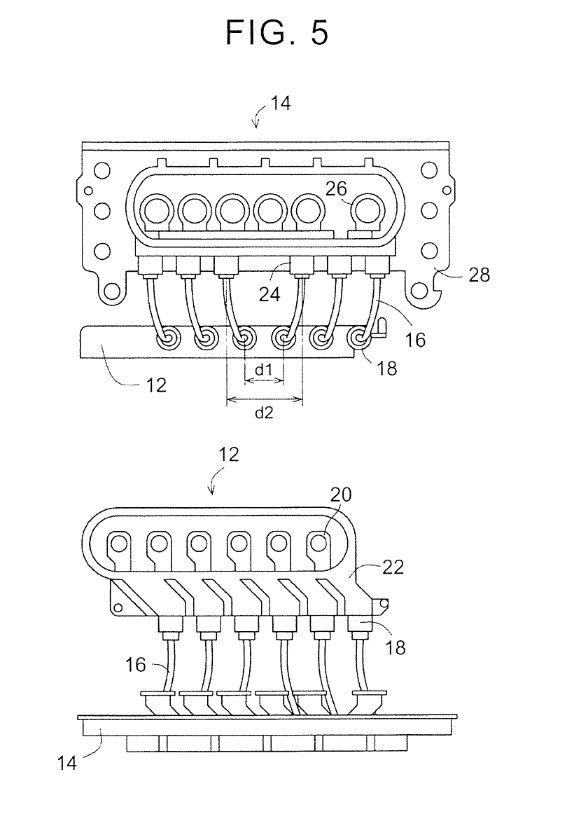

FIG. 4 and FIG. 5 show another example of the cable unit 10 according this embodiment. FIG. 4 shows a perspective view of the cable unit 10, and FIG. 5 shows a side view and a plan view of the cable unit 10. In this example, an arrangement interval d1 of the sockets 18 of the T/A side connector 12 and arrangement interval d2 of the sockets 24 of the PCU side connector 14 are different from each other. By doing so, the cable 16 is bent gradually to an inner side from the PCU side connector 14 and connected with the T/A side connector 12. This way, the cable 16 is routed into a curved shape that is curved three-dimensionally.

In the example shown in FIG. 4 and FIG. 5, a bending deformation amount of the cable 16 is smaller compared to the spiral routing shown in FIG. 1. In other words, bending of the cable 16 is shallower. Generally, when the cable 16 with a large diameter is used, restoring force is generated in the cable 16 against bending deformation. The restoring force increases in proportion to the bending deformation amount. The restoring force also acts on, and thus applies stress on root parts of the cable 16, that is, the sockets 18, 24 and the plugs 23. By reducing the bending deformation amount of the cable 16, the restoring force is reduced, and it is thus possible to relax stress applied on the sockets 18, 24 and the plugs 23.

In order to further reduce the restoring force against bending deformation, it is possible to give the cable 16 flexibility. For example, diameters of the electric wire strands, which are bundled as the cable 16, may be reduced to be smaller than those of the related art, and the number of bundled electric wire strands may be increased more than that of the related art. This way, it is possible to provide the cable 16 with flexibility without changing a sectional area of the electric wire bundle.

What is claimed is:

1. A cable unit for a vehicle, the cable unit comprising:
a first connector connected with a terminal block of a transaxle case that houses a rotating electric machine;
a second connector connected with a terminal block of a power control unit case that houses an inverter; and
a cable that connects the first connector with the second connector, the cable being routed into a curved shape to be curved three-dimensionally, and the cable being deformed when the transaxle case and the power control unit case move relative to each other as the vehicle is driven.

2. The cable unit according to claim 1, wherein
the first connector includes a first socket into which the cable is inserted,
the second connector includes a second socket into which the cable is inserted, and
an insertion direction axis of the first socket and an insertion direction axis of the second socket are positioned to be skew to each other.

3. The cable unit according to claim 1, wherein
the first socket includes a plurality of sockets,
the second socket includes a plurality of sockets,
an arrangement interval of the plurality of sockets included in the first socket and an arrangement interval of the plurality of sockets included in the second socket are different from each other.
